(19) United States
(12) Patent Application Publication
(10) Pub. No.: US 2025/0226480 A1
(43) Pub. Date: Jul. 10, 2025

(54) REAL-TIME TEMPERATURE MEASUREMENT METHOD FOR TRACTION BATTERY PACK

(71) Applicant: Xiamen Yudian Automation Technology Co., Ltd., Xiamen (CN)

(72) Inventor: Yu ZHOU, Xiamen (CN)

(73) Assignee: Xiamen Yudian Automation Technology Co., Ltd., Xiamen (CN)

(21) Appl. No.: 19/087,444

(22) Filed: Mar. 21, 2025

Related U.S. Application Data
(63) Continuation of application No. PCT/CN2022/126342, filed on Oct. 20, 2022.

(30) Foreign Application Priority Data
Oct. 13, 2022 (CN) 202211255274.6

(51) Int. Cl. H01M 10/633; G01R 31/3842; H01M 10/48

(52) U.S. Cl. CPC H01M 10/633; G01R 31/3842; H01M 10/486

(57) ABSTRACT

Provided in the present invention is a real-time temperature measurement method for a traction battery pack. The temperature measurement and thermal field analysis of a traction battery pack are realized. A temperature field of a traction battery pack is simulated and emulated by using current and voltage information of the traction battery pack and thermodynamic parameters of a material, and the temperature field is corrected by using discrete actually-measured temperature data and by means of a deep neural network and a Kalman filter, such that an established temperature field model can more truly reflect the actual temperature field distribution of the battery pack.

### TECHNICAL FIELD

The invention particularly relates to a real-time temperature measurement method for a traction battery pack.

### BACKGROUND

Vigorously promoting new energy is one of the themes of development in today's era. Battery packs composed of power battery cells in series, parallel, and mixed connections have been widely used in industries such as electric bicycles, electric vehicles, and industrial power systems. However, traction battery packs have problems such as aging, bulging and even catching fire, which seriously hinders its promotion. The thermal field imbalance problem of battery packs has attracted much attention in the industry. Therefore, establishing an accurate and effective traction battery pack temperature field model will help effectively evaluate the distribution characteristics and changes of the battery temperature field, and it is an important research direction in current battery thermal management.

There are many types of power batteries, among them, lithium batteries are widely used due to their advantages such as high energy density and long service life. Among lithium batteries, an 18650 cylindrical battery is the most widely used standard battery, where 18 represents 18 mm in diameter, 65 represents 65 mm in length, and 0 represents cylindrical battery. The advantages of the 18650 battery pack include large capacity, high safety performance, small internal resistance, fixed size, large capacity selection range, mature welding process, etc., and are increasingly favored by people in the industry.

Currently, methods for measuring and monitoring the temperature of traction battery packs can be roughly divided into two categories. One category is to utilize optical fiber, infrared imaging, surface acoustic waves or directly utilize temperature sensitive components to perform temperature monitoring, which can be called external temperature monitoring methods; the other category is to utilize the self-generated characteristics and parameters of the battery or convection and turbulence models to perform thermodynamics simulation, which can be called internal temperature monitoring methods. A sensor is placed close to a measured object and reflects the temperature of the measured object through the thermal balance theorem, and this temperature measurement method is often used in situations where there are fewer temperature measurement points. If the number of sampling points is increased, the engineering difficulty such as sensor layout, wiring placement, and circuit interface design will increase exponentially, making it difficult to arrange too many temperature sensors. Compared with the external temperature measurement methods for the battery, the internal temperature measurement methods are mainly implemented by establishing corresponding models. For example, an impedance-based temperature measurement method is one of the internal temperature measurement methods, and this method is on the basis of a large amount of experimental data [3]. There are also methods of using computational fluid dynamics and finite element analysis software to perform numerical calculations and thermodynamic simulations by introducing conduction and convection models. The difference between the battery thermodynamic model and the actual heat generation/heat transfer of the battery, as well as errors in parameters such as specific heat and conduction, will lead to deviations in the calculation of the battery pack temperature field.

In view of this, how to improve the accuracy of battery pack temperature field computation is a technical problem that needs to be solved in this field.

### SUMMARY

An objective of the present invention is to provide a real-time temperature measurement method for a traction battery pack.

The present invention aims to solve the problem on accuracy of real-time temperature measurement for the traction battery pack.

To solve the above problem, the present invention is implemented through the following technical solutions:

A real-time temperature measurement method for a traction battery pack comprises:
acquiring voltage parameters and current parameters of the traction battery pack in a discharge state;
acquiring measured temperature values of a plurality of sampling points of the battery pack;
inputting a plurality of measured temperature values into a Kalman prediction model to obtain next prediction temperature values of the sampling points;
inputting the next prediction temperature values, the voltage parameters and the current parameters into a battery pack temperature field model to obtain a three-dimensional space theoretical temperature field of the battery pack;
establishing a deep neural network model mapped from the three-dimensional space theoretical temperature field to all temperature nodes; and
calling the deep neural network model, and predicting the temperature of other positions through the temperature of the sampling points in the battery pack, so as to obtain a corrected three-dimensional space temperature field approximate to a real temperature field.

Further, the deep neural network model is a three-dimensional convolutional neural network, and the convolution algorithm formula is:

$${y}_{ijk} = {\sum }_{u = 1}^{U} {\sum }_{v = 1}^{V} {\sum }_{w = 1}^{W} {ω}_{uvw} {x}_{( i - u + \frac{U + 1}{2} ) ( j - v + \frac{V + 1}{2} ) ( k - w + \frac{W + 1}{2} )}$$

x represents an input three-dimensional matrix; y represents an output three-dimensional matrix; i, j and k represent coordinates of three dimensions; U, V and W represent the three-dimensional size of a convolution kernel, which are odd numbers; and @ represents an element value of the convolution kernel.

Further, the real-time temperature measurement method further includes: training the deep neural network model.

Further, a deep neural network training method for the deep neural network model includes:
S1, inputting the plurality of measured temperature values to a discriminator;
S2, performing discrete sampling on the corrected temperature field to obtain an estimated temperature value, and inputting the estimated temperature value to the discriminator; enabling sampling coordinates for discrete sampling on the corrected temperature field to be in one-to-one correspondence with sampling coordinates of the measured temperature inputted to the discriminator;
S3, outputting a determination result by the discriminator and feeding back the determination result to the deep neural network model;
S4, performing optimization on the deep neural network model according to the determination result, and generating a new corrected temperature field; and
S5, repeating steps S1 to S4 until the accuracy of the discriminator is 50%±ε, and then finishing the optimization of the deep neural network model.

Further, ε≤1%.

Further, the discriminator is a binary classifier and outputs a result that the measured temperature value or the estimated temperature value is determined.

Further, the formula of the battery pack temperature field model is:

$${C}_{cell} \frac{\partial {T}_{cell}}{\partial t} = γ ( \frac{{\partial }^{2} {T}_{cell}}{\partial {R}^{2}} + \frac{1}{R} \frac{\partial {T}_{cell}}{\partial R} ) + \frac{{Q}_{S}}{V} + \frac{{Q}_{P}}{V} \\ {Q}_{S} = {T}_{cell} I \frac{\partial {E}_{emf}}{\partial {T}_{cell}} , {Q}_{P} = {I}^{2} {R}_{θ} ,$$

C_{cell} represents specific heat capacity of a battery; Tcell represents temperature of the battery; t represents charging and discharging time; γ represents a heat conductivity coefficient; R represents radius of the battery; QS represents reversible reaction heat; QP represents polarization reaction heat and joule heat of the battery; V represents volume of the battery; I represents charging and discharging current of the battery; Eemf represents open-circuit voltage of the battery; and Rθ represents equivalent internal resistance of the battery.

Further, the formula of the Kalman prediction model is:

$$τ i ( k + 1 / k ) = a τ i ( k / k - 1 ) + β ( k ) [ ti ( k ) - c τ i ( k / k - 1 ) ]$$

the prediction gain equation is:

$$β ( k ) = \frac{acP ( k \vert k - 1 )}{{c}^{2} P ( k \vert k - 1 ) + {σ}_{v}^{2}}$$

the mean square prediction error equation is:

$$P ( k + 1 \vert k ) = a 2 P ( k \vert k - 1 ) - ac β ( k ) P ( k \vert k - 1 ) ] + σ w 2$$

the initial condition is computed to obtain τi(1|0)=ti(1), β(k)=0, and thus the next prediction temperature τi(k+1|k) of the sampling points is obtained;
a represents a state transition parameter, c represents a measurement gain, and the state transition parameter and the measurement gain are both constants; and δ represents time delay from temperature sampling to result output.

Further, the method further includes: establishing a sensing network for the traction battery pack of a specified model.

Compared with the prior art, the technical solutions and the beneficial effects of the present invention are as follows:
(1) The present invention refers to the idea of a deep learning Generative Adversarial Network (GAN) model; the three-dimensional convolutional neural network model is innovatively introduced; and the core parameter solution in the Kalman prediction model is also brought into the deep learning iterative training process of the neural network model, so that the model has three-dimensional space correlation and stronger real-time performance.
(2) According to the present invention, the temperature of the limited sampling points, the voltage parameters and the current parameters of the battery pack are used as the constraints for the battery pack temperature field model to deduce the current theoretical temperature field of the battery pack, and the application range is wide.
(3) The present invention refers to the idea of the generative adversarial network model, and the temperature measurement, voltage and current values of a small number of three-dimensional space discrete points are utilized to effectively invert the three-dimensional temperature field of the traction battery pack.
(4) According to the present invention, the three-dimensional convolutional neural network is deduced from the conventional deep learning two-dimensional convolution, the limited measured data is converted into the three-dimensional space theoretical temperature field through the battery pack temperature field model, and then the three-dimensional space theoretical temperature field is used for generating a three-dimensional space correction temperature field which is approximate to the real temperature field through the three-dimensional convolutional neural network, so that the correlation of the three-dimensional space information is reserved, and the more real information of the three-dimensional space of the battery pack is obtained.

### BRIEF DESCRIPTION OF DRAWINGS

FIG. 1 is a flowchart of a real-time temperature measurement method for a traction battery pack according to an embodiment of the present invention;

FIG. 2 is an algorithm block diagram of a Kalman prediction model according to an embodiment of the present invention.

FIG. 3 is a flowchart of a real-time temperature measurement method for a traction battery pack according to an embodiment of the present invention, including a neural network training process;

FIG. 4 is a measured distribution diagram of a temperature field of an 18650 traction battery pack according to an embodiment of the present invention, (a) is a measured temperature distribution diagram of a temperature sensor in a middle layer, and (b) is a measured temperature distribution diagram of a temperature sensor at a bottom layer;

FIG. 5 is a three-dimensional structural modeling diagram of an 18650 traction battery pack according to an embodiment of the present invention;

FIG. 6 is a schematic diagram of grid division of an 18650 traction battery pack model according to an embodiment of the present invention; and

FIG. 7 is a three-dimensional space temperature field distribution diagram of an 18650 traction battery pack according to an embodiment of the present invention, (a) is a three-dimensional space theoretical temperature field, and (b) is a corrected three-dimensional space temperature field.

### DETAILED DESCRIPTION OF THE EMBODIMENTS

In order to make the purpose, technical solutions and advantages of the embodiments of the present invention clearer, the technical solutions in the embodiments of the present invention will be clearly and completely described below in conjunction with the drawings in the embodiments of the present invention. Obviously, the described embodiments are some embodiments of the present invention, rather than all embodiments. It is to be understood that the specific embodiments described here are only used to explain the present invention and are not intended to limit the present invention. Based on the embodiments of the present invention, all other embodiments obtained by those of ordinary skill in the art without making creative efforts fall within the scope of protection of the present invention.

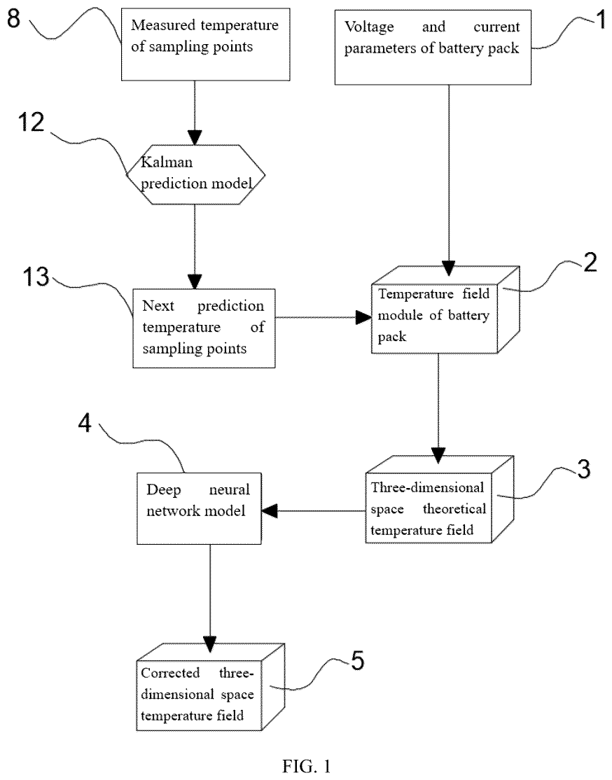

As shown in FIG. 1, a real-time temperature measurement method for a traction battery pack includes:
S1: Establish a sensing network for the traction battery pack of a specified model. This step includes: selecting a position where the temperature needs to be measured in the battery pack, and placing a temperature sensor at the position; and completing hardware connection and software communication among the temperature sensor, a temperature measuring instrument, a charging device and an upper computer, which are the prior art and not described any more.
S2: Acquire measured temperature values 8 of a plurality of sampling points of the battery pack through the sensing network.
S3: Acquire voltage parameters and current parameters 1 of the traction battery pack in a discharge state.
S4: Input a plurality of measured temperature into a Kalman prediction model to obtain a next prediction temperature value 13 of the sampling points.

The Kalman prediction model 12 is used for optimally estimating a random signal, and involves prediction for a signal τi(k) at a k moment through a signal at a k−1 moment in the filtering process, i is an integer and may be 1, 2, . . . , n, and n is the number of sampling points. A mathematical model of the random signal to be estimated can be assumed to be a first-order recursive process driven by a white noise sequence {w(k)}, and its dynamic equation is:

$${τ}_{i} ( k ) = a {τ}_{i} ( k - 1 ) + w ( k - 1 )$$

the mathematical model in the measuring process has white noise {v(k)} disturbance, and its dynamic equation is:

$${t}_{i} ( k ) = c {τ}_{i} ( k ) + v ( k )$$

a represents a state transition parameter, c represents a measuring gain, and the state transition parameter and the measuring gain are both constants. w(k−1) represents process noise which is also named as system noise, v(k) represents measuring noise, square mathematical expectations of w(k−1) and v(k) are sigma σw2 and σv2 respectively, which are both constants, belong to unknown variables in the training model, and need to be continuously optimized and solved in iterative operation. The formula of the Kalman prediction model 12 is:

$$τ i ( k + 1 \vert k ) = a τ i ( k \vert k - 1 ) + β ( k ) [ ti ( k ) - c τ i ( k \vert k - 1 ) ]$$

the prediction gain equation is:

$$β ( k ) = \frac{acP ( k \vert k - 1 )}{{c}^{2} P ( k \vert k - 1 ) + {σ}_{v}^{2}}$$

the mean square prediction error equation:

$$P ( k + 1 \vert k ) = a 2 P ( k \vert k - 1 ) - a c β ( k ) P ( k \vert k - 1 ) + σ w 2$$

the initial condition is computed to obtain τi(1|0)=ti(1), β(k)=0, and optimal estimation τi(k+1|k) of the random signal of the next sampling point can be obtained according to the above formulas.

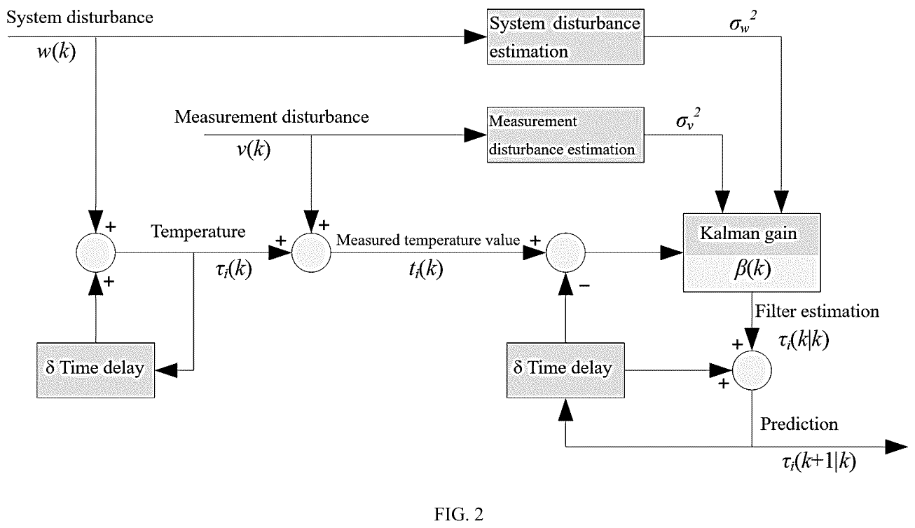

FIG. 2 is an algorithm block diagram of the Kalman prediction model 12. δ represents the time delay from temperature sampling to result outputting. Since a certain time is required for the operation of a prediction algorithm, and a temperature field output result actually has the time delay of a period δ, a result of the period δ needs to be predicted forwards.

The Kalman prediction model 12 can adaptively change according to a motion state, so as to achieve an optimal filtering effect. The measured data and estimated data are ingeniously fused, and closed-loop management is performed on errors, so that random errors can be effectively limited, and then an optimal estimation effect is achieved.

S5: Input next prediction temperature values 13, voltage parameters and current parameters 1 to a battery pack temperature field model 2, so as to obtain a three-dimensional space theoretical temperature field 3 of the battery pack.

The formula of the battery pack temperature field model 2 is:

$${C}_{cell} \frac{\partial {T}_{cell}}{\partial t} = γ ( \frac{{\partial }^{2} {T}_{cell}}{\partial {R}^{2}} + \frac{1}{R} \frac{\partial {T}_{cell}}{\partial R} ) + \frac{{Q}_{S}}{V} + \frac{{Q}_{P}}{V}$$

QS and QP are obtained by the following equations:

$${Q}_{S} = {T}_{cell} I \frac{\partial {E}_{emf}}{\partial {T}_{cell}}$$

$${Q}_{P} = {I}^{2} {R}_{θ}$$

the formulas of QS and QP are substituted into the formula of the battery pack temperature field model to obtain:

$${C}_{cell} \frac{\partial {T}_{cell}}{\partial t} = γ ( \frac{{\partial }^{2} {T}_{cell}}{\partial {R}^{2}} + \frac{1}{R} \frac{\partial {T}_{cell}}{\partial R} ) + \frac{1}{V} {T}_{cell} I \frac{\partial {E}_{emf}}{\partial {T}_{cell}} + \frac{{I}^{2} {R}_{θ}}{V}$$

Ccell represents specific heat capacity of a battery; Tcell represents temperature of the battery; t represents charging and discharging time; γ represents a heat conductivity coefficient; R represents radius of the battery; QS represents reversible reaction heat; QP represents polarization reaction heat and joule heat of the battery; V represents volume of the battery; I represents charging and discharging current of the battery; Eemf represents open-circuit voltage of the battery; and Re represents equivalent internal resistance of the battery.

S6: Establish a deep neural network model 4 mapped from the three-dimensional space theoretical temperature field 3 to all temperature nodes, and obtain a corrected three-dimensional space temperature field 5 by the three-dimensional space theoretical temperature field 3 through the deep neural network model 4.

The deep neural network model 4 is a generative neural network, may be a self-encoder/decoder, U-net, Transformer and the like, and may also be a common neural network such as a fully connected network. The formula of the deep neural network model 4 is as follows:

$${y}_{ijk} = {\sum }_{u = 1}^{U} {\sum }_{v = 1}^{V} {\sum }_{w = 1}^{W} {ω}_{uvw} {x}_{( i - u + \frac{U + 1}{2} ) ( j - v + \frac{V + 1}{2} ) ( k - w + \frac{W + 1}{2} )} \qquad ( 1 )$$

x represents an input three-dimensional matrix; y represents a calculation result, and is also a three-dimensional matrix; i, j and k represent coordinates of three dimensions; U, V and W represent the three-dimensional size of a convolution kernel, which are odd numbers; and ω represents an element value of the convolution kernel.

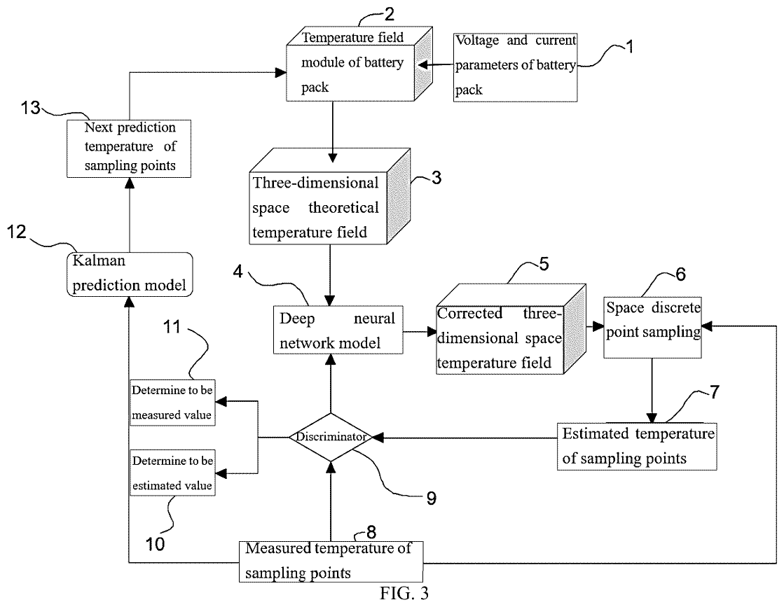

As shown in FIG. 3, the deep neural network model 4 is continuously optimized, so that the mapping relation between the three-dimensional space theoretical temperature field 3 and a real temperature field is more accurate. The deep neural network model is optimized through the following steps:

S61: Input a plurality of actually measured temperature values to a discriminator 9, the discriminator 9 being a classifier, and the classifier being binary, which may be in forms of LDA, SVM, KNN, Decision Tree, Random Forest, Bayes, ANN, and the like.

S62: Perform discrete sampling on the corrected temperature field 5 to obtain an estimated temperature value 7, and input the estimated temperature value 7 to the discriminator 4, sampling coordinates 6 for discrete sampling on the corrected temperature field 5 being in one-to-one correspondence with sampling coordinates of the measured temperature inputted into the discriminator 9 in step S61.

S63: Output a determination result by the discriminator 9 and feed back the determination result to the deep neural network model 4. The discriminator 9 outputs a result that the measured temperature value 11 or the estimated temperature value 10 is determined, and the two results includes one of the measured temperature value and the estimated temperature value.

S64: Perform optimization on the deep neural network model 4 according to the determination result, and generate a new corrected temperature field 5.

S61 to S64 are repeated, namely alternative optimizing is performed on the discriminator 9 and the deep neural network model 4, and repeated iteration is performed until the discriminator 9 cannot distinguish the measured temperature value 11 from the estimated temperature value 10, that is, the corrected three-dimensional space temperature field 5 outputted by the deep neural network model 4 is very approximate to the measured temperature field, and then the training of the deep neural network model 4 is finished. In this embodiment, when the binary accuracy of the discriminator is 50%±ε, it is regarded that the discriminator 9 cannot distinguish the measured temperature value 11 from the estimated temperature value 10, and the numerical value of & may be set according to a specific condition; and in this embodiment, ε≤1%, so that a more optimized deep neural network model is obtained.

S7: Call the deep neural network model, predict the temperature of other positions through the temperature of the sampling points in the battery pack to obtain the corrected temperature field 5 infinitely approaching the actual temperature field, thus finishing the real-time temperature measurement for the traction battery pack.

Taking an 18650 battery pack as an example, the measurement method according to the present invention will be further described below.

In this embodiment, the 18650 battery pack includes 49 battery cells, 7 battery cells are in series, and 7 battery cells are in parallel; the 18650 battery cells are Panasonic NCR18650BD, and 46.8 g in weight; each cell has nominal voltage of 3.7 V, and capacity of 3,200 mAh. In the 7×7 battery packs, 6×6=36 slit gaps are available for placing the temperature sensors, 2 sensors are placed in each slit and are respectively placed in the middle and at the bottom, and 72 thermocouple temperature sensors are placed in total; and hardware connection and software communication connection among the thermocouple temperature sensors, a load, a host, the charging device and the temperature measuring instrument are completed.

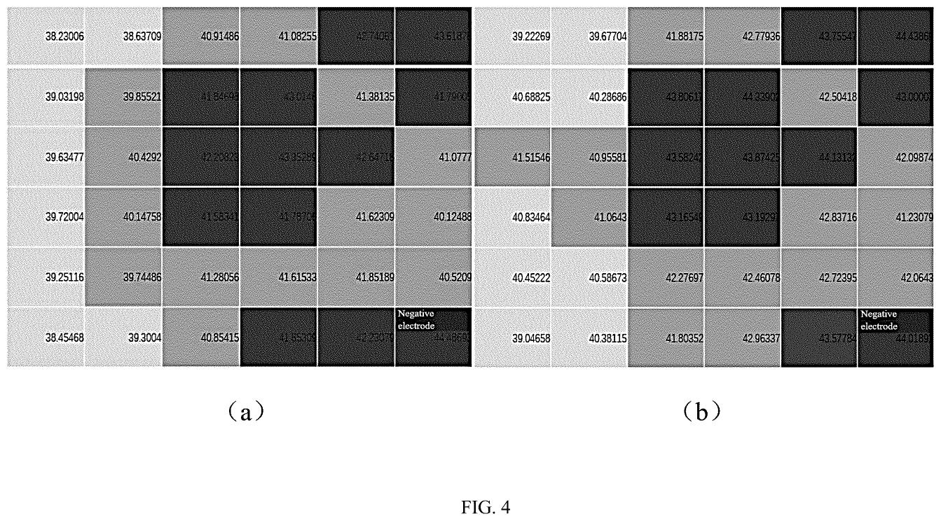

As shown in FIG. 4, the 72 temperature sensors of the traction battery pack output results at a certain moment, (a) shows temperature distribution of 36 temperature sensors in the middle layer, and (b) shows the temperature distribution of 36 temperature sensors at the bottom layer.

The structures of the 18650 battery cells are drawn with SOLIDWORKS, a battery pack assembly diagram is also drawn, and then three-dimensional temperature field simulation is performed on the 18650 battery pack based on finite element analysis software ANSYS Workbench in combination with the measured data. The three-dimensional model established with SOLIDWORKS is imported into ANSYS Workbench for simulation, and the three-dimensional model is established according to the equal proportion of the real traction battery pack.

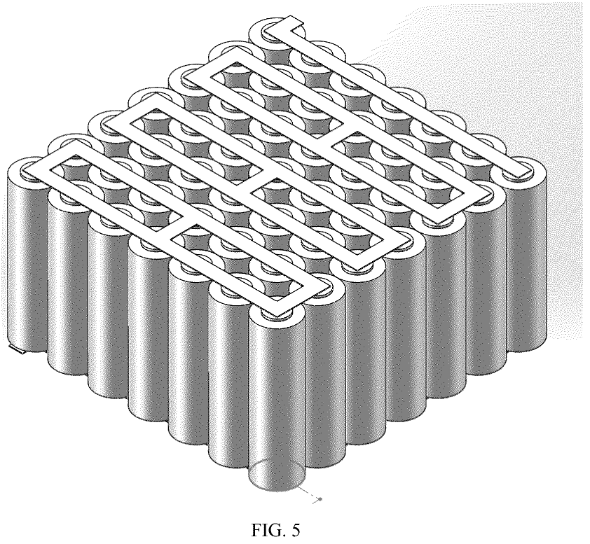

As shown in FIG. 5, the battery pack model is composed of forty-nine 18650 battery cells, each battery cell is cylindrical, the diameter of the cylinder is 18 mm, and the height of the cylinder is 65 mm.

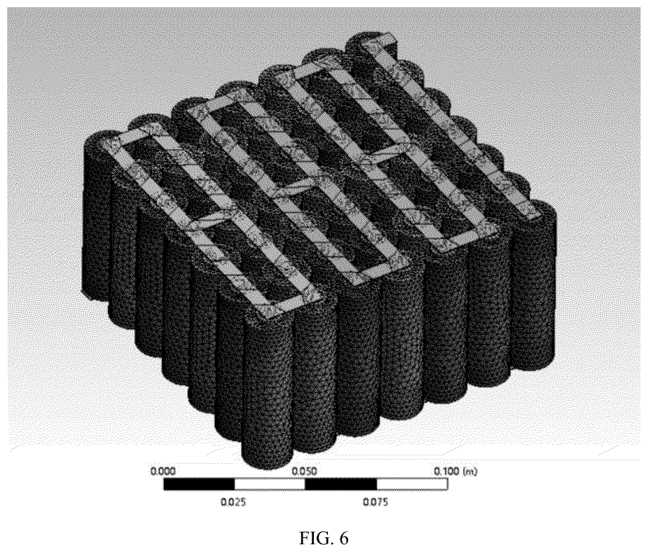

Then the three-dimensional model established with SOLIDWORKS is imported into ANSYS Workbench for grid division, and the grid division is shown in FIG. 6.

After the specification parameters and material characteristics of the battery cells and the battery pack are known, the temperature of each point of the battery pack after a certain period of battery discharge is computed, and then the three-dimensional space theoretical temperature field is further constructed through the battery pack temperature field model.

In this embodiment, the deep neural network model 4 is of a U-net structure. A temperature field simulation node is divided in the three-dimensional space of the battery pack at an interval of 1 mm, the volume of each node is 1 mm3, and 126×126×65 temperature field simulation nodes are provided in total and are mapped to the corrected 126×126×65 temperature nodes through U-net for approaching the actual temperature field distribution of the battery pack. Different from thee conventional deep neural network for processing a two-dimensional image, three-dimensional information is processed for the battery pack temperature field, so as to more completely save the associated information of the three-dimensional space of the temperature field.

In this embodiment, the discriminator 9 is of a fully-connected ANN structure and has 7 layers, the first 6 layers are subjected to linear operation, the number of nodes is 32, 16, 8, 4, 2, 1 in sequence, the last layer is an activation function, and the activation function is a step function and belongs to nonlinear operation; and output is divided into a 0 state and a 1 state, 0 represents that a sampling point is discriminated as estimated temperature, and 1 represents that the sampling point is discriminated as actually-measured temperature.

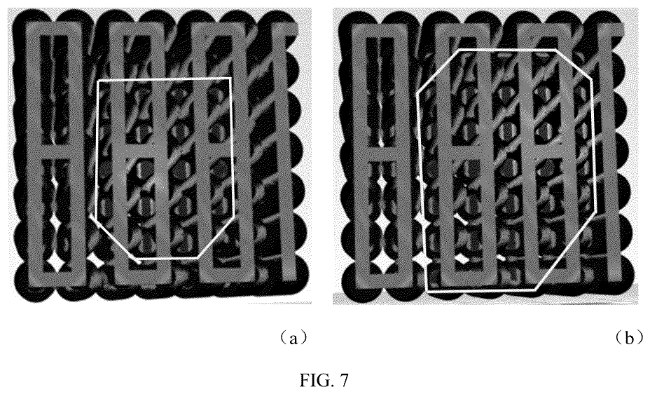

The deep neural network model is trained according to the measured temperature value through the method shown in FIG. 3, and then the three-dimensional space temperature field of the 18650 battery pack is obtained according to the real-time temperature measurement method for the traction battery pack shown in FIG. 1. As shown in FIG. 7, (a) shows the three-dimensional space theoretical temperature field of the traction battery pack computed through the battery pack temperature field model, and (b) shows the corrected three-dimensional space temperature field of the traction battery pack outputted by the deep neural network model 4, and a relatively high-temperature area is drawn in the circle; and compared with the measured temperature distribution diagram in FIG. 4, it can be seen that the corrected temperature distribution is approximate to actual thermal field distribution.

The above description illustrates and describes preferred embodiments of the present invention. It is to be understood that the present invention is not limited to the form disclosed herein and should not be regarded as an exclusion of other embodiments. It can be used in various other combinations, modifications, and environments, and can be modified within the scope of the present invention concept through the aforementioned teachings or relevant technical or knowledge in the field. Any modifications and changes made by personnel in this field that do not deviate from the spirit and scope of the present invention shall be within the scope of protection of the claims attached to the present invention.

What is claimed is:

1. A real-time temperature measurement method for a traction battery pack, comprising:
acquiring voltage parameters and current parameters of the traction battery pack in a discharge state;
acquiring measured temperature values of a plurality of sampling points of the battery pack;
inputting a plurality of measured temperature values into a Kalman prediction model to obtain next prediction temperature values of the sampling points;
establishing a battery pack temperature field model, and inputting the next prediction temperature values, the voltage parameters and the current parameters into the battery pack temperature field model to obtain a three-dimensional space theoretical temperature field of the battery pack;
establishing a deep neural network model mapped from the three-dimensional space theoretical temperature field to all temperature nodes; and
calling the deep neural network model, and predicting the temperature of other positions through the temperature of the sampling points in the battery pack, so as to obtain a corrected three-dimensional space temperature field approximate to a real temperature field.

2. The real-time temperature measurement method for the traction battery pack according to claim 1, wherein the deep neural network model is a three-dimensional convolutional neural network, and the convolution algorithm formula is:
$${y}_{ijk} = {\sum }_{u = 1}^{U} {\sum }_{v = 1}^{V} {\sum }_{w = 1}^{W} {ω}_{uvx} {x}_{( i - u + \frac{U + 1}{2} ) ( j - v + \frac{V + 1}{2} ) ( k - w + \frac{W + 1}{2} )}$$
wherein x represents an input three-dimensional matrix; y represents an output three-dimensional matrix; i, j and k represent coordinates of three dimensions; U, V and W represent the three-dimensional size of a convolution kernel, which are odd numbers; and ω represents an element value of the convolution kernel.

3. The real-time temperature measurement method for the traction battery pack according to claim 1, further comprising: training the deep neural network model.

4. The real-time temperature measurement method for the traction battery pack according to claim 3, wherein a deep neural network training method for the deep neural network model comprises:
S1, inputting the plurality of measured temperature values to a discriminator;
S2, performing discrete sampling on the corrected temperature field to obtain an estimated temperature value, and inputting the estimated temperature value to the discriminator; enabling sampling coordinates for discrete sampling on the corrected temperature field to be in one-to-one correspondence with sampling coordinates of the measured temperature inputted to the discriminator;
S3, outputting a determination result by the discriminator and feeding back the determination result to the deep neural network model;
S4, performing optimization on the deep neural network model according to the determination result, and generating a new corrected temperature field; and
S5, repeating steps S1 to S4 until the accuracy of the discriminator is 50%±ε, and then finishing the optimization of the deep neural network model.

5. The real-time temperature measurement method for the traction battery pack according to claim 4, wherein ε≤1%.

6. The real-time temperature measurement method for the traction battery pack according to claim 4, wherein the discriminator is a binary classifier and outputs a result that the measured temperature value or the estimated temperature value is determined.

7. The real-time temperature measurement method for the traction battery pack according to claim 1, wherein the formula of the battery pack temperature field model is:
$${C}_{cell} \frac{\partial {T}_{cell}}{\partial t} = γ ( \frac{{\partial }^{2} {T}_{cell}}{\partial {R}^{2}} + \frac{1}{R} \frac{\partial {T}_{cell}}{\partial R} ) + \frac{{Q}_{S}}{V} + \frac{{Q}_{P}}{V}$$
wherein
$${Q}_{S} = {T}_{cell} I \frac{\partial {E}_{emf}}{\partial {T}_{cell}} , {Q}_{P} = {I}^{2} {R}_{θ} .$$
C_{cell} represents specific heat capacity of a battery; T_{cell} represents temperature of the battery; t represents charging and discharging time; γ represents a heat conductivity coefficient; R represents radius of the battery; Q_{S} represents reversible reaction heat; Q_{P} represents polarization reaction heat and joule heat of the battery; V represents volume of the battery; I represents charging and discharging current of the battery; E_{emf} represents open-circuit voltage of the battery; and R_{θ} represents equivalent internal resistance of the battery.

8. The real-time temperature measurement method for the traction battery pack according to claim 1, wherein the formula of the Kalman prediction model is:
$$τ i ( k + 1 \vert k ) = a τ i ( k \vert k - 1 ) + β ( k ) [ ti ( k ) - c τ i ( k \vert k - 1 ) ]$$
wherein the prediction gain equation is:
$$β ( k ) = \frac{acP ( k \vert k - 1 )}{{c}^{2} P ( k \vert k - 1 ) + {σ}_{v}^{2}}$$
the mean square prediction error equation is:
$$P ( k + 1 \vert k ) = a 2 P ( k \vert k - 1 ) - a c β ( k ) P ( k \vert k - 1 ) + σ w 2$$
the initial condition is computed to obtain τᵢ(1|0)=tᵢ(1), β(k)=0, and thus the next prediction temperature τᵢ(k+1|k) of the sampling points is obtained;
a represents a state transition parameter, c represents a measurement gain, and the state transition parameter and the measurement gain are both constants; and δ represents time delay from temperature sampling to result outputting.

9. The real-time temperature measurement method for the traction battery pack according to claim 1, further comprising: establishing a sensing network for the traction battery pack of a specified model.
